(19) United States
(12) Patent Application Publication
(10) Pub. No.: US 2006/0093407 A1
(43) Pub. Date: May 4, 2006

(54) Image forming method and image forming apparatus

(75) Inventors: Hiroshi Toda, Okazaki-shi (JP); Kenzou Toya, Okazaki-shi (JP); Makoto Takase, Okazaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/234,216

(22) Filed: Sep. 26, 2005

(30) Foreign Application Priority Data
Nov. 4, 2004 (JP) JP2004-320313

(51) Int. Cl. G03G 15/08

(52) U.S. Cl. 399/284

(57) ABSTRACT

A developer regulation member for use in an electrophotographic image forming apparatus, the developer regulation member forming a thin developer layer by coming in contact with developer conveyed on a developer carrying member, wherein the developer regulation member comprises titanium or titanium compound excluding TiN and TiBN.

### BACKGROUND

1. Field of the invention

The invention relates to an image forming method and an image forming apparatus employing a single component developer.

2. Description of Related Art

Recently, rising in the reliability of the image forming apparatus by electrophotographic system is demanded and a developing apparatus (developing device) is required by which the image quality can be stabilized for a long period.

The developing method employing the single-component developer almost comprising by a toner is widely applied for a printer since the structure of the developing device can be simplified.

However, it is necessary in the single-component developer that the toner is electrically charged by the friction with a developer regulation member for forming a developer layer on a developer carrying member even though the structure of the developing device is simple. Contrary to that, the charging of the toner is carried out by the friction with the carrier in the double-component developing method. Therefore, a problem tends to be caused, particularly, the uniformly charging can be difficultly attained. As a countermeasure to such the problem, it is usual that the developer layer formed on the developer carrying means is made to relatively thin and uniform as to be possible for stabilizing the electric charge.

However, the developer layer is formed by regulating the developer conveyed by the developer carrying member by the developer regulating member in such the method. Therefore, rubbing stress is applied to the developer at this portion, and the stress is made larger when the developer layer is made thinner. Such the stress causes degradation in the developer. Consequently, it is required to establish a method for uniformly and stably charging the developer with stress as low as possible.

The single-component developer is different from the double-component developer, almost constituted by colored particles including a colorant and a binder resin and an external additive, which is usually called as the toner, accordingly the developer and the developer layer are each frequently referred to as the toner and the toner layer, respectively.

As the countermeasure to the above-problem in the single-component developer, many kinds of material such as various kinds of resin, a metal plate, a metal plate on which Cr or Ni is plated, and a metal plate on which a resin is pasted have been investigated for the toner regulation member. However, any one having the durability sufficiently satisfying the required level of the reliability is not obtained yet. Moreover, the stability of the electric charge of the toner is not satisfied by them, for example cf Patent Documents 1 and 2.

The parts plated by Cr or Ni further have some problems such as that a electrolytic solution of Cr or Ni is necessary for production thereof, and the powder of the metal caught in the toner on the occasion of the regulation of the toner conveying amount causes variation in the charging ability and an image defect such as spots. There is a subject relating to the correspondence to the recent environmental problems.

Patent Document 1: Tokkai Hei 9-165136

Patent Document 2: Tokkai 2000-206776

An object of the invention is to provide an image forming method and an image forming apparatus having high durability where the single-component developer can be stably and uniformly electrically charged for a long period.

### SUMMARY

Aspects of the invention can be (1) a developer regulation member for use in an electrophotographic image forming apparatus, wherein the developer regulation member forms a thin developer layer by coming in contact with developer conveyed on a developer carrying member, the developer regulation member comprising: titanium or titanium compound excluding TiN and TiBN;

(2) an image forming method comprising:

forming a latent electrostatic image on a photoreceptor, conveying developer with a developer carrying member, forming a thin developer layer by coming in contact with the developer with a developer regulation member as defined in (1)above; and developing the latent electrostatic image by using the thin developer layer,

(3) an image forming apparatus comprising a developing device for developing a latent electrostatic image, the developing device comprising: a developer carrying member for conveying developer, and a developer regulation member as defined in (1) above.

### BRIEF DESCRIPTION OF THE DRAWINGS

FIG. 1 shows a cross section of an example of full color image forming apparatus.

FIG. 2 shows a cross section displaying the arrangement of a developer carrying member (developing sleeve) and a toner regulation member.

### DETAILED DESCRIPTION OF THE PREFERRED EMBODIMENT

Compounds, members, an image forming method and an apparatus relating to the invention are described below.

Toner (developer) regulating member plated with titanium:

The shape of the toner regulation member includes blade shape and a block shape and each of which further includes various variations; the invention can be applied to the above entire toner regulation members. Materials such as a metal, a resin and a rubber are usable for the toner regulation member, the invention may be applied to all of them.

In particularly preferable embodiment of the invention, the blade-shaped is preferable from the viewpoints of the thin layer forming ability, the easiness of provision and the durability, and the metal plate such as a steel plate, particularly a stainless steel plate is preferable from the points of the durability, the easiness of production and the titanium plating.

In the toner regulation member plated with titanium, particularly the stainless plate plated with titanium, the barrier effect of the plated titanium layer and the cathode anticorrosion effect of the titanium oxide layer can be fully enhanced by forming a titanium oxide layer on the plated titanium layer since the adherence of the titanium oxide layer to the developer regulating member is improved when the titanium oxide is provided on the titanium layer.

Though the reason of that the titanium oxide layer displays high adhesion ability when the titanium oxide layer is formed on the plated titanium layer is not cleared yet, it is supposed that a naturally oxide layer of the titanium formed on the outermost surface of the plated titanium layer mitigates the steep variation in the composition between the titanium layer and the later formed titanium oxide layer and forms an incline in the composition, as a result of that high adhesion ability of the layer can be obtained at the processed portion after a mechanical processing such as bending.

The titanium layer (the plated titanium layer) is preferable for realizing the excellent durability particularly in the flat portion, and the thickness thereof is preferably from 0.5 to 10 μm. When the thickness is 0.5 μm or more, pinholes are likely to reduce and the barrier effect of the titanium becomes sufficient; and when the thickness 10 μm or less, the production efficiency and the economical advantage are considerably improved.

The provision of the titanium oxide layer is effective for displaying the excellent durability by cathode anticorrosion at the pinhole in the under layer of plated titanium, and at the exposed portion of the substrate caused by the mechanical processing. The thickness of the titanium oxide layer is preferably from 0.1 to 5 μm. The weather-proof ability becomes sufficient when the thickness is 0.1 μm or more, and the adhesion ability of the titanium oxide layer is improved when the thickness 5 μm or less. The cathode anticorrosion is made larger when the thickness is 0.8 μm or more so that the durability, particularly the durability at the edge portion, is further increased. Accordingly, it is desirable to make the thickness to 0.8 μm or more when further high durability is necessary.

There is no specific limitation on the stainless steel plate as the substrate. Various kinds of stainless palate can be employed corresponding to the purpose of use. One having small immersion potential difference between titanium is preferable. For example, an austenite stainless steel such as SUS304 is usable.

The production method of the titanium plated steel plate of the invention is described below. There is no specific limitation on the stainless steel plate as the substrate and various kinds of stainless palate can be applied.

The formation method of the titanium layer on the stainless palate surface can be applied without any limitation. An ion plating method, a physical vapor deposition method such as a vacuum vapor deposition method, and a chemical vapor deposition method are applicable.

The forming method of the titanium oxide layer is not specifically limited as long as that is the physical vapor deposit method. Though the ion plating method and the vacuum vapor deposit method are also applicable, and the vacuum vapor depositing method is preferable because in the case of the ion plating method the electric current is difficultly flowed when the layer thickness becomes thick since the titanium oxide layer has low electric conductivity and irregular discharge tends to occur so as to form unevenness in the layer thickness. The titanium oxide obtained such the methods is TiO₂ having preferable high purity which cannot be realized by a sol-gel method or a chemical vapor deposition method.

In the above columns, toner regulation member plated by titanium is described. Further, effective toner regulation member can be formed by using titanium alloy or titanium compound.

As the titanium compound alloys containing titanium such as TiC, TiAlN ,TiAlCN are applicable.

Further, as the titanium compound a coated layer can be applicable, which is formed by coating on a substrate such as a metal, the mixture of resin and fine particles of titanium oxide, such as titanium white and titanium black, and by drying the coated layer.

As the crystal form of the titanium oxide, there are rutile structure, anatase structure, and brookite structure, and titanium oxide of all of these crystal forms can be applicable.

Further as the titanium compound, organic titanium compounds such as tetraisopropyltitanate, titan-acetylacetoacetonate, and titan-etylacetoacetonate can be used singularly or by mixing with silane coupling agent by coating and drying on a substrate.

By using titanium compound or titanium alloy, the toner regulation member can be formed as follows.

In cases of using alloys containing titanium such as TiC, TiAlN, and TiAlCN, it may be prepared by forming a coat layer of titanium compound on the surface of substrate made of stainless steel plate by ion plating method or vapor deposition method, or may be prepared by coating fine particulated titanium compound dispersed in resin on the surface of the substrate.

In cases of using fine particles of titanium oxide, it may be prepared after forming coating liquid by dispersing the fine particles of titanium oxide in solution prepared by solving a known resin such as polyvinylbutyral into organic solvent such as 2-butan and tetrahydrofuran, by coating the coating liquid on a substrate by any known coating method such as spray coating method, dipping method, and cascade coating method.

In cases of using organic titanium compound as the titanium compound, a coated layer containing titanium may be provided on the surface of a substrate made of stainless steel etc., by forming coating liquid by solving organic titanium compound (tetraisopropyltitanate), and silane coupling agent (3-aminopropyltrimethoxysilane) into isopropanol, coating the coating liquid on the surface of stainless steel substrate, and drying the coated layer.

In cases of using the fine particles of titanium compound by dispersing in resin, the area of the surface where the titanium compound is exposed on the surface of the developer regulation member is preferably 10% or more of the total surface area of the regulation member, and more preferably 30% or more.

The titan metal or titan compound is contained in at least a portion of the developer regulation member where the portion comes in contact with the developer. Inorganic oxide particle of element of Group IV (IUPAC 1989):

The inorganic oxide particle of an element of Group IV (IUPAC 1989) is used as an external additive, which is concretely fine particle of oxide of Ti, Zr or Hf. The size of the particle is preferably from 0.01 to 0.5 μm in number average diameter of primary particles.

When the size is less than 0.01 μm, the adhering force of the particle is strengthened in some degree since the particle is too small so that the particle tends to adhere to the developer regulating member and the effect of the invention is difficultly obtained. When the size exceeds 0.5 μm, the adhering force with the toner particle is lowered so that the oxide particle tends to adhere to the developer regulating member instead of the toner particle, and the weakening the effect of the invention tends to be resulted.

Incidentally, the number average diameter of primary particles of the external additive can be measured as follows:

Taking a photograph of 30,000 times magnified image of the toner including additive particles, and taking in the photographed image by an image scanner. By using Image Analyzer LUZEX AP (made by NIRECO Corporation), binary processing is applied to the image of additive particles attached to the surface of toner, Feret diameters in horizontal direction are calculated for 100 particles per kind of additives, and assumes average value of these as the number average diameter of the primary particles. Incidentally, if the external additive is present as secondary particle on the colored particle, the diameter of primary particles constituting the secondary particle is employed to obtain the number average diameter of the primary particles.

The materials and the techniques relating to the invention are described in detail below.

Materials and producing method to be applied to toner

The production method of the toner employed in the invention is not specifically limited and ones produced by a usual crushing method, suspension polymerization method or emulsion polymerization process is acceptable. However, the most preferable method is a method in which resin particles are prepared in an aqueous medium by emulsion polymerization method and the plural resin particles are associated and fused to form the toner. Such the method is suitable for forming the toner having uniform toner particles and median diameter (d50) in volume distribution of 3 to 8 μm with a narrow diameter distribution, which is useful in the invention.

Accordingly, the preparation of toner by the method by the association and fusion of fine resin particles is mainly described below.

(1) Polymerizable Monomer

The polymerizable monomer includes a hydrophobic monomer, a hydrophilic monomer and a crosslinkable monomer, and the hydrophobic monomer is essential and the hydrophilic monomer and the crosslinkable monomer are employed according to necessity.

1) Hydrophobic Monomer

As the hydrophobic monomer for constituting the monomer composition, known monomers can be employed without any limitation. One or more kinds of the monomer can be employed in combination for satisfying required properties.

In concrete, alpha-methylene aliphatic mono-carboxylate such as a mono-vinyl aromatic monomer and a (meth)acrylate monomer, a vinyl ester monomer, a vinyl ether monomer, a mono-olefin monomer, a di-olefin monomer and a halogenated olefin monomer are usable.

Examples of the vinyl aromatic monomer include a styrene monomer such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene and 3,4-dichlorostyrene, and a derivative thereof.

Examples of the acryl monomer include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl beta-hydroxyacrylate, propyl gamma-ammoacrylate, stearyl methacrylate, dimethylaminoethyl methacrylate and dimethylaminoethyl methalate.

Examples of the vinyl ester monomer include vinyl acetate, vinyl propionate and vinyl benzoate.

Examples of the vinyl ether monomer include vinyl methyl ether, vinyl ethyl ether, vinyl isobutyl ether and vinyl phenyl ether.

Examples of the mono-olefin monomer include ethylene, propylene, iso-butylene, 1-butene, 1-pentene and 4methyl-1-pentene.

Examples of the di-olefin monomer include butadiene, isoprene and chloroprene.

2) Hydrophilic Monomer

As the hydrophilic monomer for constituting the monomer composition, known monomers can be employed without any limitation. One or more kinds of them may be used in combination for satisfying required properties.

For example, a carboxyl group-containing monomer, a sulfonic acid-containing monomer and an amine compound such as a primary amine, a secondary amine, a tertiary amine and a quaternary ammonium salt are employable.

Examples of the carboxyl group-containing monomer include acrylic acid, methacrylic acid, fumaric acid, maleic acid, itaconic acid, cinnamic acid, mono-butyl maleate and mono-octyl maleate.

Examples of the sulfonic acid group-containing monomer include styrenesulfonic acid and octyl allylsulfosaccinate.

Examples of the amine compound include dimethylaminoethyl acrylate, dimethylaminoethyl methacrylate, diethylaminoethyl acrylate, diethylaminoethyl methacrylate, 3-dimethylaminophenyl acrylate and 2-hydroxy-3-methacryloxypropyltrimethylammonium salt.

3) Crosslinkable Monomer

The crosslinkable monomer may be added for improving the properties of the polymerized particles. As the crosslinkable monomer, a compound having two or more unsaturated groups such as divinylbenzene, divinylnaphthalene, divinyl ether, diethylene glycol methacrylate, poly(ethylene glycol dimethacrylate and diallyl phthalate is usable.

In the invention, the monomers are suitably selected within the range of from 99.9 to 85% by weight of the hydrophobic monomer and from 0.1 to 15% by weight of the hydrophobic monomer.

(2) Chain-Transfer Agent

Usually used chain-transfer agents can be employed for controlling the molecular weight of the polymer without any limitation. For example, a mercaptan such as octylmercaptan, dodecylmercaptan and tert-dodecylmercaptan is employed.

(3) Polymerization Initiator

A water-soluble radical polymerization initiator can be optionally employed in the invention. For example, a persulfate such as potassium persulfate and ammonium persulfate, an azo compound such as 4,4′-azobis-4-cyanovarelic acid and its salt and 2,2′-azobis(2-aninopropane) and its salt, and a peroxide compound are employable.

The above polymerization initiators may be used as a redox type initiator by combining with a reducing agent. The activity of polymerization is raised so that the polymerization temperature can be lowered, and shortening in the polymerization time can be expected by the use of the redox type polymerization initiator.

Any polymerization temperature can be applied as long as the temperature is higher than the radical forming temperature, for example, a temperature of from 50° C. to 80° C. is applicable. The polymerization can be carried out at a room temperature or less by the use of a polymerization initiator capable of initiating the polymerization at a room temperature such as a combination of hydrogen peroxide and a reducing agent such as ascorbic acid.

(4) Surfactant

When a surfactant is employed, for example, a sulfonic acid salt such as sodium dodecylbenzenesulfonate, sodium arylalkylpolyethersulfonate, sodium 3,3-disulfondiphenylurea-4,4-diazo-bis-amino-8-naphthol-6-sulofonate, ortho-carboxybenzene-azo-dimethylaniline and sodium 2,2,5,5-tetramethyl-triphenylmethane4,4-azo-bis-beta-naphtho-6-sulfonate, a sulfuric ester salt such as sodium tetradecylsulfate, sodium pentadecylsulfate and sodium octylsulfate, a fatty acid salt such as sodium oleate, sodium laurate, sodium caprate, sodium capronate, potassium stearate and calcium oleate are employable.

(5) Colorant

1) Inorganic Pigment

A known inorganic pigment can be employed. Concrete inorganic pigments are exemplified below even though any pigment can be employed.

As black pigment, for example, a carbon black such as furnace black, channel black, acetylene black, thermal black and lump black, and a magnetic powder such as magnetite and ferrite are employable.

These inorganic pigments may be employed singly or in combination of plural kinds thereof when it is desired. The adding amount of the pigment is from 2 to 20, and preferably from 3 to 15, parts by weight of the polymer.

2) Organic Pigment

Known organic pigments can be employed. Concrete typical examples of the organic pigments are listed below.

Examples of pigment for red or magenta color include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 166, C. I. Pigment Red 177, C. I. Pigment Red 178 and C. I. Pigment Red 222.

Examples of pigment for orange or yellow color include C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 93, C. I. Pigment Yellow 94 and C. I. Pigment Yellow 138.

Examples of pigment for green or cyan color include C. I. Pigment Blue 15, C. I. Pigment Blue 15:2, C. I. Pigment Blue 15:3, C. I. Pigment Blue 16, C. I. Pigment Blue 60 and C. I. Pigment Green 7.

These organic pigments may be employed singly or in combination of plural kinds thereof when it is desired. The adding amount of each of the pigments is from 2 to 20, and preferably from 3 to 15, parts by weight of the polymer.

3) Surface Modifying Agent

A known surface modifying agent can be applied to the colorants. In concrete, a silane compound, a titanium compound and an aluminum compound are preferably usable.

Examples of the silane compound include an alkoxysilane such as methyltrimethoxysilane, phenyltrimethoxysilane, methylphenyldimethoxysilane and diphenyldimethoxysilane, a siloxane such as hexamethyldisiloxane, and gamma-chloropropyltrimethoxysilane, vinyltrichlorosilane, vinyltrimethoxysilane, vinyltriethoxysilane, gamma-methacryloxypropyltrimethoxysilane, gamma-glycidoxypropyltrimethoxysilane, gamma -mercaptopropyl-trimethoxysilane, gamma-aminopropyltriethoxysilane and gamma-ureidopropyltriethoxysilane.

Examples of the titanium compound include TTS, 9S, 38S, 41B, 46B, 55, 138S and 238S each are manufactured and sold by Ajinomoto Co., Inc., under the commercial name of PLENACT, A-1, B-1, TOT, TST, TAA, TAT, TLA, TOG, TBSTA, A-10, TBT, B-2, B4, B-7, B-10, TBSTA40, TTS, TOA-30 TSDMA, TTAB and TTOP each sold by Nihon Soda Co., Ltd.

Example of the aluminum compound is PLENACT AL-M manufactured by Ajinomoto Co., Inc.

The using amount of the surface modifying agent is from 0.01 to 20%, and preferably from 1 to 15%, by weight of the colorant.

(6) Parting Agent

Known parting agents, for example, low molecular weight polyethylene, low molecular weight polypropylene, polyethylene and polypropylene each subjected to an oxidation treatment (including ones subjected to an acid modification treatment), carnauba wax and a fatty acid amide can be used.

(7) Electric Charge Controlling Agent

Known electric charge controlling agents maybe used However, the electric charge controlling agent is not necessary in some cases when a monomer having a polar group is copolymerized at the surface of the polymerized particle. The polar group is a group having a negative or positive electric charge such as a carboxyl group, a sulfonic acid group, an amino group and an ammonium group.

A nigrosin type electron donating dye, a metal salt of naphthenic acid or a fatty acid, an alkoxylamine, a quaternary ammonium salt, an alkylamide, a metal complex and a fluorinated surfactant are employable as a positive electric charge controlling agent, and an electron acceptable organic complex and copper phthalocyanine are employable as a negative charge controlling agent

(8) Production Method of Toner

1) Surface Treatment of Toner

In the surface modifying method, the colorant is dispersed in a solvent, the surface modifying agent is added to the resultant dispersion and then the temperature of the system is raised for progress of the reaction. After the completion of reaction, the colorant is filtered and washed by the same solvent repeatedly and dried to obtain the pigment treated by the surface modifying agent

2) Dispersion of Colorant

The colorant is dispersed in an aqueous phase containing the surfactant in a concentration of not less than CMC. A mechanical dispersing means such as a sand grinder, an ultrasonic means, a dispersion means by pressure such Manton-Gaulin homogenizer are used for dispersion the pigment.

3) Formation of Polymerized Fine Particles (Emulsion Polymerization)

In the production process of the pigment-containing polymerized particles according to the invention, the colorant treated by the surface modifying agent is dispersed in a surfactant solution having a concentration of not less than CMC, and the resultant dispersion was diluted so that the surfactant concentration becomes to a concentration of not more than CMC. In the diluted dispersion, a water soluble radical polymerization initiator is dissolved and an ethylenic unsaturated monomer is added. Thereafter, the precipitation polymerization in the aqueous system is performed to obtain the pigment-containing polymerized particles. The colorant is included into the polymerized particles by such the method.

4) Association and Fusion Process

The toner is produced by association and fusion of the colorant-containing composite particles prepared as above.

Various methods of the association and the fusion are described in, for example, Tokkai Sho 60-220358 and Tokkai Hei 4-284461. However, the desired particle diameter and its distribution are difficultly controlled by such the methods. Consequently, the inventors prepare non-spherical particles by the method described in Tokkai Hei 5-115572, in which a coagulation agent in a concentration larger that the critical coagulation concentration of the polymer fine particle dispersion and a solvent infintely dissolvable in water are added to the dispersion of the dispersion.

Though the colored particles to be main material of the toner are obtained as above, a dispersing agent, emulsifying agent or surfactant is generally employed in the polymerization process of the colored particle according to such the polymerization method. When these hydrophilic substances are leaved in the final toner, degradation in the charging property, particularly variation of the charging ability depending on the environmental conditions, is caused so that the image cannot be obtained stably.

Therefore, a process is essential, by which the hydrophilic substances are removed by washing from the resin fine particles formed by the polymerization method. The washing is commonly performed by repeat of washing and filtration.

It is necessary that thus obtained colored particles are subjected to a treatment for separating the solid from the liquid for finally obtaining the dried and powdered toner. A method is suitably applied, in which the dispersion of colored particles is subjected to decantation, filtration and centrifugation to obtain the particles in a form of a cake, and the cake was dried by removing the remaining moisture by heating or pressure reducing. The particles are obtained in a form of physically coagulated lump such as dried blocks or flakes by such the process, though the colored particles are not fused with together.

The coagulated lumps are decoagulated, namely the colored particles in the state of coagulated and dried lump are taken to unit particles of the toner. It is necessary in concrete method to apply mechanical impact within the degree of not crushing the colored particle itself for taking the lumps to the state of individual particles. In concrete, the lumps can be effectively powdered while preventing the destroy of the associated fine particles when the circumference rate of the high speed rotating wings of a HENSCHEL MIXER is from 15 to 50 m/sec, preferably from 20 to 40 m/sec.

When the block- or flake-shaped lumps before the decoagulation is coarse, a roughly crushing process by a hummer mill may be provided for preliminary powdering.

Moreover, an external additive necessary for the toner may be added to the powdering system simultaneously with the coagulated lumps or in the course of the powdering of the coagulated lumps for providing the external additive onto the surface of the colored resin particles on the occasion of the powdering. When the external additive is added in the course of the powdering, the driving condition of the powdering apparatus may be varied after the addition within the suitable range.

(9) Example of Employable External Additive

Known various kinds of inorganic fine particle, organic fine particles and a lubricant maybe employed additionally to the inorganic oxide particle of the element of Group IV (IUPAC 1989).

1) Inorganic Fine Particle

Various kinds of inorganic oxide, nitride and boride such as silica, alumina, titania, zirconia, barium titanate, aluminum titanate, strontium titanate and silicon nitride are suitably employable. These inorganic fine particles are preferably subjected to a hydrophobilizing treatment by various coupling agents.

2) Organic Fine Particle

Various kinds of resin particles composed of a vinyl resin, a silicone resin, a fluororesin or melamine resin are suitably employed.

3) Lubricant

As the lubricant, a salt of a higher fatty acid such as stearic acid or oleic acid of a metal such as aluminum, sodium, strontium, calcium or zinc is usable.

Preparation of developer:

The toner produced as the above can be employed as the non-magnetic single-component developer. However, it is necessary to add fine particles of magnetic substance having a median diameter (d50) in volume distribution of from 0.1 to 2.0 μm to toner in an amount of from 20 to 70% by weight when the toner is employed for a magnetic single-component developer.

Measurement of toner particle diameter:

The media diameter (d50) in volume distribution can be measured by Coulter Counter TA-2 or Coulter Multisizer, each manufactured by Beckman Coulter, Inc.

Image Forming Method

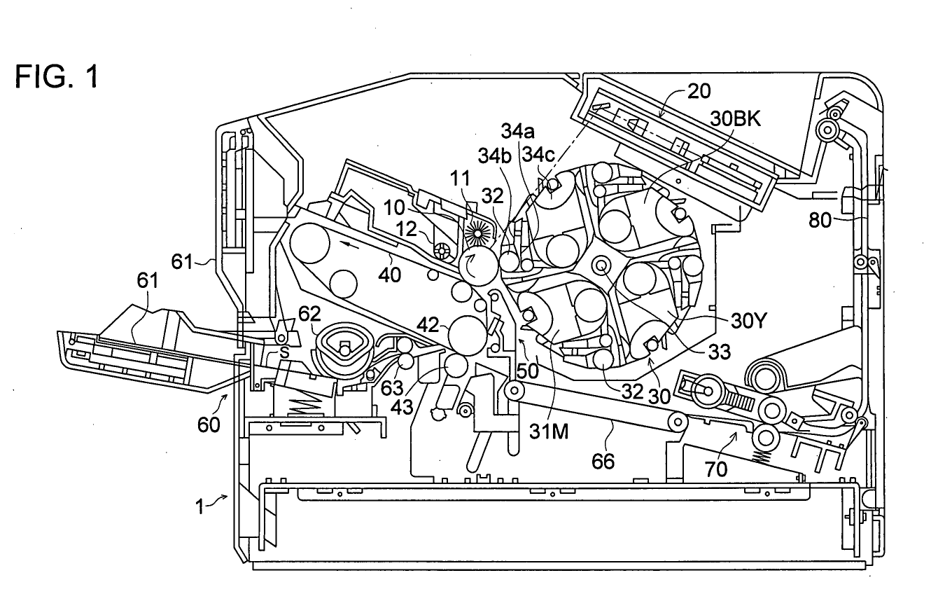

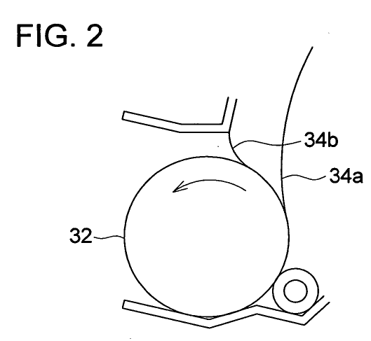

An example of fill color image forming apparatus for forming a fill color image by the use of the above toners is described referring FIGS. 1 and 2.

In the full color image forming apparatus shown in FIG. 1, a charging brush 11 for uniformly electrically charging the surface of a photoreceptor drum 10 at a designated potential, and a cleaner 12 for scraping the toner remaining on the photoreceptor drum 10 are arranged around the photoreceptor 10.

Moreover, a laser scanning optical system 20 for exposing the photoreceptor 10 electrically charged by the charging brush 11 to a laser beam is provided. The laser scanning optical system 20 is known one including a laser diode, a polygon mirror and an f□ optical element, and cyan, magenta, yellow and black data to be printed are transferred from a host computer to the controlling means thereof The laser scanning optical system 20 successively outputs laser beams according to the data of each of the above colors to expose the photoreceptor drum 10 for successively forming electrostatic latent images on the photoreceptor drum 10.

The developing apparatus 30 for supplying each of the color toners to the photoreceptor drum 10 to perform full color development is constituted by four developing devices 31C, 31M, 31Y and 31Bk each containing a cyan, magenta, yellow and black non-magnetic single-component toners, respectively, which are arranged around the supporting axis 30. The developing devices can be rotated around the axis 33 so that each of the developing devices 31C, 31M, 31Y and 31Bk are successively introduced at a position facing to the photoreceptor drum 10.

In each of the developing devices 31C, 31M, 31Y and 31Bk of the full color developing apparatus 30, two toner regulation members 34a and 34b are contacted by pressure to a developer carrier 32 (developing sleeve) for conveying the toner by rotation. The amount of the toner conveyed by the developing sleeve 32 is regulated by the toner regulation members 34a and 34b and the conveyed toner is electrically charged at the same time. In this full color developing apparatus 30, the toner regulation member of course can be made one, though the two toner regulation member 34a and 34b are provided for suitably performing the regulation and electrically charging the toner conveyed by the developing sleeve.

The full color developing apparatus is rotated around the supporting axis 33 every formation of the electrostatic latent image of each color so that the developing devices 31C, 31M, 31Y and 31Bk each containing the corresponding color toner are successively introduced to the position where the developing device is faced to the photoreceptor drum 10. And then each of the color toners are successively supplied onto the electrostatic latent image successively formed on the photoreceptor drum 10 by contacting the developing sleeve 32 contained in the each of the developing devices 31C, 31M, 31Y and 31Bk for performing the development.

An endless intermediate transfer belt 40 is provided at the downstream side from the full color developing apparatus 30 in the rotating direction of the photoreceptor drum 10. The intermediate transfer belt 40 is driven for synchronously rotating with the photoreceptor drum 10. The intermediate transfer belt 40 is contacted with the photoreceptor drum 10 by being pressed by a rotatable primary transfer roller 41, and a rotatable secondary transfer roller 43 is provided for facing to a support roller 42 supporting the intermediate transfer belt 40. A recording member S such as recording paper is pressed by the secondary transfer roller 43 for contacting to the intermediate transfer roller 40.

A cleaner 50 for scraping off the toner remaining on the intermediate belt 40 is provided in the space between the full color developing apparatus 30 and the intermediate transfer belt 40 so that the cleaner 50 can be contacted to and released from the intermediate transfer belt 40

A paper supplying means 60 for introducing the recording member S such as recording paper to the intermediate transfer belt 40 is constituted by a paper supplying tray 61 for storing the recording member S, a paper supplying roller 62 for supplying one by one the recording member S stored in the paper supplying tray 61 and a timing roller 63 for sending the recording member S between the intermediate belt 40 and the secondary transfer roller 43 synchronously with the translation of the image on the intermediate transfer belt 40. The recording member conveyed between the intermediate transfer belt 40 and the secondary transfer roller 43 is pressed against the intermediate transfer belt 40 by the secondary transfer roller 43 so that the toner image is transferred by press onto the recording member S.

The recording member S on which the toner image is transferred by press is introduced to a fixing device 70 by a conveying means 66 constituted by an air suction belt. The toner image transferred onto the recording member S is fixed in the fixing device 70, and then the recording member S is take out on the upper face of the image forming apparatus 1 through a vertical conveying pass 80.

The procedure for forming a fill color image by this full color image forming apparatus is described below.

The photoreceptor drum 10 and the intermediate transfer belt 40 are rotated in each of their directions and the photoreceptor drum 10 is electrically charged to a designated potential by the charging brush 11.

An electrostatic latent image of a cyan image is formed by exposing the charged photoreceptor drum 10 according to the cyan image data by the laser scanning optical system 20. And then a cyan image is developed by supplying an electrically charged cyan toner on to the photoreceptor drum 10 from the developing device 31C containing the cyan toner through the toner regulation members 34a and 34b. The cyan toner image formed on the photoreceptor drum 10 is primarily transferred onto the intermediate transfer belt 40 by contacting by press the intermediate transfer belt 40 to the photoreceptor drum 10 by the primary transfer roller 41.

After the transfer of the cyan toner image onto the intermediate transfer belt 40, the full color developing apparatus 30 is rotated around the supporting axis 33 for introducing the developing device 31M containing a magenta atoner to the position for facing to the photoreceptor drum 10. And then a magenta image is exposed to the charged photoreceptor drum 10 by the laser scanning optical system 20 for forming an electrostatic latent image in the same manner as in the cyan image formation. The electrostatic image is developed by the developing device 31M containing the magenta toner and the developed magenta toner image is primarily transferred onto the intermediate transfer belt 40 from the photoreceptor drum 10. Furthermore, exposure, development and primarily transfer of a yellow image and black image are successively performed so that a full color toner image is formed by successively piling the cyan, magenta, yellow and black images on the intermediate transfer belt 40.

After the primarily transfer of the last black image on to the intermediate transfer belt 40, the recording member S is conveyed by timing roller 63 between the secondary transfer roller 43 and the intermediate transfer belt 40, and the full color toner image formed on the intermediate transfer belt 40 is secondarily transferred onto the recording member S by pressing the recording member S against the intermediate transfer belt 40 by the secondary transfer roller 43.

After the secondary transfer of the full color toner image onto the recording member S, the recording member S is introduced into the fixing device 70 by the conveying means 60. The toner image transferred onto the recording member S is fixed by the fixing device 70, and then the recording member S is taken out onto the upper face of the image forming apparatus 1 through the vertical conveying pass 80.

### EXAMPLE 1

Typical embodiments of the invention is described below for further describing the constitution and the effects of the invention, but the invention is not limited to these embodiments. Preparation of developer regulation member:

Developer regulation members No. 1 through No. 6 were prepared by forming a titanium layer by ion plating or vacuum vapor deposition, or further forming a titanium oxide layer on an SUS 304 stainless steel plate having a thickness of 0.1 mm to be employed as the substrate. The layer forming conditions were as follows.

Titanium layer formation by ion plating;

The stainless steel plate was preliminary heated at a temperature of from 100 to 300° C. and subjected to a pre-treatment by Ar ion bombardment, and then pure titanium was heated and vaporized by an electron beam under a atmosphere pressure of not more than 133×10⁻⁵ Pa and ionized, and the ionized titanium particle is deposited on the steel plate applying a negative voltage of from −100 to −500 V while the steel plate was heated at the temperature of from 100 to 350° C.

Titanium layer formation by vacuum vapor deposition;

The stainless steel plate was preliminary heated at a temperature of from 100 to 300° C. and subjected to a pre-treatment by Ar ion bombardment, and then pure titanium was heated at the temperature of from 100 to 350° C. and vaporized by an electron beam under an atmosphere pressure of not more than 133×10⁻⁵ Pa to form a layer on the steel plate.

Formation of titanium oxide layer by vacuum deposition;

A layer of titanium oxide was formed by heating and vaporizing TiO₂ under an atmosphere pressure of 266×10⁻⁴ Pa in terms of a partial pressure of oxygen.

Thus prepared developer regulation members are described below.

Other than the above, samples without titanium plating were prepared as comparing samples which were referred to as developer regulation members 7 through 9.

TABLE 1

| | Titanium plating | | Titanium oxide layer | |
|---|---|---|---|---|
| Developer | | Layer | | Layer |
| regulation | Forming | thickness | | thickness |
| member | method | (μm) | Forming method | (μm) |
| 1 | Ion plating | 1.0 | Vacuum deposition | 1.0 |
| 2 | Ion plating | 1.0 | None | — |
| 3 | Vacuum | 1.0 | Vacuum deposition | 4.0 |
| | deposition | | | |
| 4 | Vacuum | 1.0 | None | — |
| | deposition | | | |
| 5 | Ion plating | 9.0 | Vacuum deposition | 1.0 |
| 6 | Vacuum | 9.0 | Vacuum deposition | 1.0 |
| | deposition | | | |
| 7 | none | — | None | — |
| 8 | none | — | Vacuum deposition | 4.0 |
| 9 | —* | — | None | — |

*Coated with 50 μm of polyvinylidenefluoride(PVDF) layer

Preparation of Single-Component Developer (Single-Component Toner):

Colored Particle Preparation Example 1

Polymerization Process

An aqueous dispersion of carbon black was prepared by adding 533.5 g of carbon black REGAL 330R, manufactured by Cabot Co., Ltd., treated by an aluminum coupling agent to 6 liter of purified water in which 246 g of sodium dodecylsulfate was dissolved, and applying ultrasonic irradiation while stirring. On the other hand, an aqueous dispersion of low molecular weight polypropylene having a solid component concentration of 20% by weight was prepared by adding a low molecular weight polypropylene having a number average molecular weight of 3200 to a surfactant solution and emulsifying the polypropylene by stirring while heating.

In a 100 liter glass lining reaction vessel of on which a stirrer having three retrogression angled wings, a baffle, a cooler and a thermo-sensor were attached, 2150 g of the low molecular wieght polypropylene aqueous dispersion was added to the above prepared aqueous dispersion of carbon black, and stirred, and 4905 g of styrene monomer, 820 g of n-butyl acrylate, 245 g of methacrylic acid, 165 g of tert-didecylmercaptane and 42.5 liter of deaerated purified water were added, and then the resultant mixture were heated by 70° C. while stirring under nitrogen gas stream, and a polymerization initiator solution composed of 205 g of potassium persulfate and 10 liter of purified water were further added. Polymerization was performed for 6 hours at 70° C. After that the reaction liquid was cooled by the room temperature. Thus obtained carbon black-containing colored dispersion was referred to as Dispersion 1. The pH of the liquid at this occasion was 4.7.

Association Process:

The pH of 45 liters of the above Dispersion 1 was adjusted to 9 by using a sodium hydroxide solution and put into a stainless steel vessel, on which a stirrer having anchor wings, a baffle, a cooler and a thermal sensor were attached, and 8 liters of 2.7 moles/liter potassium chloride aqueous solution, 7 liters of isopropyl alcohol and an aqueous solution composed of 30 liter of purified water and 810 g of polyoxyethyleneoctylphenyl ether (the average polymerization degree of the polyethylene oxide was 10) dissolved in the water were added to form associated particles. After that, the inner temperature of the vessel was raised by 85° C. and stirred for 6 hours. Then the system is cooled by the room temperature to obtain Colored Particle 1. The median diameter (D50) in volume distribution of Colored Particle 1 was 4.5 μm.

Preparation Example of Colored Particle 2;

Colored particles according to the invention were prepared in the same manner as in Colored Particle 1 except that C. I. Pigment Yellow 17 was employed in place of the carbon black. Thus obtained dispersion and colored particle were each referred to as Dispersion 2 and Colored Particle 2, respectively. The median diameter (D50) in volume distribution of the Colored Particle 2 was 4.8 μm.

Preparation Example of Colored Particle 3;

Colored particles according to the invention were prepared in the same manner as in Colored Particle 1 except that C. I. Pigment Red 122 was employed in place of the carbon black. Thus obtained dispersion and colored particle were each referred to as Dispersion 3 and Colored Particle 3, respectively. The median diameter (D 50) in volume distribution of the Colored Particle 3 was 4.8 μm.

Preparation Example of Colored Particle 4;

Colored particles according to the invention were prepared in the same manner as in Colored Particle 1 except that C. I. Pigment Blue 15:3 was employed in place of the carbon black. Thus obtained dispersion and colored particle were each referred to as Dispersion 4 and Colored Particle 4, respectively. The median diameter (D 50) in volume distribution of the Colored Particle 4 was 4.7 μm.

To each of Colored Particles 1 through 4, 0.5% by weight of TiO₂ having a number average particle diameter of 0.2 μm and 1.0% by weight of hydrophobic silica having a number average diameter of primary particles of 12 nm were added as the external additive to prepare Toners 1 through 4, respectively.

Evaluation Method:

The above toners 1 through 4 were charged into the image forming apparatus shown in FIG. 1, and practical printing test of 100,000 sheets was carried out with respect to each of the foregoing developer regulation members. As the image forming apparatus, in concrete, a color printer Color Page Works L (made by Minolta Corporation) was used.

1) Variation in the Electric Charging Amount of Toner

The electric charging amount of Toner 1 was measured at the initial time and after the printing of 100,000 sheets.

The measurement was performed by a suction type small electric charge measuring apparatus Model 210HS 2A.

2) Measurement of Developed Image Density and Fog

The densities of the solid black area and solid white area of the image formed only by Toner 1 at the initial time and after the printing of 100,000 sheets were measured. The measurement was performed at 5 points in each of the black and white areas, and the averages of each of the densities at 5 points were referred to as the developed image density or the maximum density and the fog, respectively, in Table 2.

3) Toner Scattering

The situation in the image forming apparatus after the printing of 100,000 sheets was observed and evaluated according to the following norms.

A: The scatter of the toner was almost not observed.

B: The scatter was observed a little.

C: The scatter was observed in a degree of not desirable for practical use.

D: The remarkable scatter was observed.

The scatter of the toner is also noted as an indicator displaying the crushing of the toner and the reversal charging of the toner caused by the stress applied during the practical printing test.

4) Image Quality

The image quality was measured based on the reproducing of fine lines and the entire feeling of the image after the printing of 100,000 sheets.

A: The fine line reproducibility was good and the image quality was fine.

B: The image quality was fine though a problem was posed a little in the fine line reproducibility.

C: The reproducibility was poor in the degree of not desirable for practical use.

D: The image quality is considerably poor from the entire feeling.

Results of the Evaluations:

The results are listed in the following Table 2.

TABLE 2

| | Charging amount of | | | | | | | |
|---|---|---|---|---|---|---|---|---|
| | toner | | | | | | | |
| | (-μC/g) | | Maximum density | | Fog | | | |
| Developer | | After | | After | | After | Scattering of | |
| regulation | At the initial | 100,000 | At the initial | 100,000 | At the initial | 100,000 | toner after | Image |
| member | time | prints | time | prints | time | prints | 100,000 prints | quality |
| 1 | 11.1 | 11.0 | 1.30 | 1.30 | 0.001 | 0.001 | A | A |
| 2 | 11.2 | 10.2 | 1.30 | 1.30 | 0.001 | 0.001 | B | B |
| 3 | 11.2 | 11.2 | 1.30 | 1.30 | 0.001 | 0.001 | A | A |
| 4 | 11.0 | 10.3 | 1.30 | 1.30 | 0.001 | 0.001 | B | B |
| 5 | 11.2 | 10.9 | 1.30 | 1.30 | 0.001 | 0.001 | A | A |
| 6 | 11.2 | 10.0 | 1.30 | 1.30 | 0.001 | 0.001 | A | A |
| 7 | 13.0 | 9.0 | 1.35 | 1.20 | 0.001 | 0.005 | D | C |
| 8 | 11.0 | 7.0 | 1.30 | 1.00 | 0.001 | 0.006 | C | C |
| 9 | 11.0 | 8.8 | 1.30 | 1.10 | 0.001 | 0.005 | C | D |

As is cleared in the results listed in Table 2, the single-component toner (the single-component developer) has satisfactory durability when the thin layer formation and the charging of the toner are performed by the developer regulation member according to the present invention.

### EXAMPLE 2

In addition to the toner regulation members used in EXAMPLE 1, following toner regulation members were prepared and evaluated by forming color images.

Preparation of Developer Regulation Member:

1) Developer Regulation Member 10

Using a stainless steel SUS304 plate of 0.1 mm thick as a substrate, titanium alloy coating layer was formed by conducting ion plating to make 2.5 □m thick of TiC layer on the substrate.

2) Developer Regulation Member 11

Dispersion liquid containing titanium compound was prepared as below.

polyvinylbutyral resin, S-LEC BL-1(madeby Sekisui chemical Co., Ltd.) 1 part by weight;

titanium oxide SMT500SAS (made by TAIKA Corporation) 4 parts by weight; and

2-buthan 10 parts by weight are dispersed by sand mill for 10 hours to make dispersion liquid.

And this dispersion liquid is coated on the substrate of stainless steel SUS304 plate of 0.1 mm thick by spray coating, and by performing 1 hour thermal processing with 100° C., coating layer of 2 μm thick containing titanium compound was formed.

3) Developer Regulation Member 12

Organic titanium compound (tetraisopropyltitanate) 12 parts by weight and silane coupling agent (3-aminopropyltrimethoxysilane)8 parts by weight are mixed and solved in 2-propanol 100 parts by weight to make a coating liquid. After coating on the substrate of stainless steel SUS304 plate of 0.1 mm thick by dipping method, by performing 1 hour thermal processing with 150° C., coating layer of 1.5 μm thick containing titanium compound was formed.

| Developer | | |
|---|---|---|
| regulation member | Titanium compound | Forming method |
| 10 | TiC | Ion plating |
| 11 | Methyl type titanium oxide fine | Spray coating |
| | particles(number median | |
| | diameter 35 nm) | |
| 12 | Tetraisopropyltitanate | Dip coating |

Evaluation Method:

The developer regulation member prepared above were applied for forming 5,000 sheets of color images by using the image forming apparatus shown in FIG. 1. More concretely, the image forming apparatus used for this evaluation was a color printer COLOR PAGE WORKS L (made by Minolta corporation). And variations in color image quality were observed by comparing full color images at start copying and at the time of 5,000 sheets copying.

A: Good result with almost no difference of image quality.

B: Although, slight variation was observed in color tone, it was allowable for practical use.

C: Considerable variation was observed, and it was not allowable for practical use.

Results of the color copy evaluation are shown in table 3.

TABLE 3

| | Charging amount | | | | | | |
|---|---|---|---|---|---|---|---|
| Developer | of toner | | Maximum density | | Fog | | Color image |
| regulation | | At 5000 | | At 5000 | | At 5000 | variation at 5000 |
| member | At start | prints | At start | prints | At start | prints | prints |
| 1 | 11.5 | 11.5 | 1.30 | 1.30 | 0.001 | 0.001 | A |
| 2 | 11.6 | 11.5 | 1.30 | 1.30 | 0.001 | 0.001 | A |
| 3 | 11.2 | 11.3 | 1.30 | 1.30 | 0.001 | 0.001 | A |
| 4 | 11.7 | 11.5 | 1.30 | 1.30 | 0.001 | 0.001 | A |
| 5 | 11.4 | 11.4 | 1.30 | 1.30 | 0.001 | 0.001 | A |
| 6 | 11.8 | 11.6 | 1.30 | 1.30 | 0.001 | 0.001 | A |
| 7 | 12.9 | 10.5 | 1.32 | 1.25 | 0.001 | 0.003 | C |
| 8 | 11.5 | 11.2 | 1.30 | 1.28 | 0.001 | 0.002 | B |
| 9 | 11.8 | 10.3 | 1.30 | 1.24 | 0.001 | 0.003 | C |
| 10 | 11.4 | 11.4 | 1.30 | 1.30 | 0.001 | 0.001 | A |
| 11 | 11.7 | 11.5 | 1.30 | 1.30 | 0.001 | 0.001 | A |
| 12 | 11.5 | 11.4 | 1.30 | 1.30 | 0.001 | 0.001 | A |

Effects of the Invention:

The toner layer regulation member shows no specific limitation on the triboelectric donation since the surface thereof is covered with the metallic titanium or titanium oxide layer. Therefore, the charging property of the toner itself can be stably maintained. Though the reason of such the effect is not cleared, it is supposed that the electric charging ability to the resin is not made excessive and some degree of electroconductivity can be given to the developer regulation member by the specific atomic orbital of the element of Group IV, and the charge can be partially leaked, accordingly the stable charging ability can be formed without excessive charging so that an image can be stably formed.

Further, by applying the toner regulation members formed by using titanium alloy or titanium compound high quality color images were stably formed.

Moreover, when the toner comprising the colored particles and the inorganic particles, particularly, the toner contained the inorganic oxide fine particle of element of Group IV (IUPAC), is employed, the electric charging ability can be stabilized for a long period and the image can be stably formed for a long period by the use of the titanium plated toner regulation member. Though the reason of such the effects is not analyzed yet, the toner is difficultly charged by the toner layer regulation member since the inorganic oxide fine particles of the element of Group IV has the molecular orbital similar to that of the titanium. Therefore, it is supposed that the triboelectricity is almost generated by the friction of the colored particles with together. As a result of that, it is supposed that there is almost no difference between the charging ability to the toner received stress by using for a long period, namely the toner particles in which the inorganic particles are buried, and that to the new toner, and the difference of the electric chargeability of the toner staying for a long period and that of the newly supplied toner is not so large, therefore, the image can be stably formed for the long period.

By the invention, the stable and uniform electric charge can be given to the single-component developer for a long period, and the image forming method and the image forming apparatus having high durability can be provided.

What is claimed is:

1. A developer regulation member for use in an electrophotographic image forming apparatus, wherein the developer regulation member forming a thin developer layer by coming in contact with developer conveyed on a developer carrying member, the developer regulation member comprising: titanium or titanium compound excluding TiN and TiBN.

2. The developer regulation member of claim 1, wherein the developer regulation member comprises a layer formed by titanium plating.

3. The developer regulation member of claim 2, wherein the developer regulation member comprises a substrate, a titanium plated layer and a titanium oxide layer.

4. The developer regulation member of claim 1, wherein the titanium compound comprises at least organic titanium compound or inorganic compound containing at least one of titanium oxide, TiC, TiAlN, and TiAlCN.

5. The developer regulation member of claim 1, comprising a portion which comes in contact with the developer, wherein the titanium or titanium compound is contained in at least the portion.

6. A developing device for an electrophotographic image forming apparatus, comprising:
a developer carrying member for conveying developer, and
a developer regulation member for forming a thin developer layer by coming in contact with the developer conveyed on the developer carrying member, wherein the developer regulation member comprises titanium or titanium compound excluding TiN and TiBN.

7. The developing device of claim 6, wherein the developer regulation member comprises a layer formed by titanium plating.

8. The developing device of claim 7, wherein the developer regulation member comprises a substrate, a titanium plated layer and a titanium oxide layer.

9. The developing device of claim 6, wherein the titanium compound comprises at least organic titanium compound or inorganic compound containing at least one of titanium oxide, TiC, TiAlN and TiAlCN.

10. An image forming apparatus composing:
a photoreceptor for carrying a latent electrostatic image; and
a developing device for developing the latent electrostatic image, the developing device comprising:
a developer carrying member for conveying developer, and
a developer regulation member for forming a thin developer layer by coming in contact with the developer conveyed on the developer carrying member,
wherein the developer regulation member comprises titanium or titanium compound excluding TiN and TiBN.

11. The image forming apparatus of claim 10, wherein the developer regulation member comprises a layer formed by titanium plating.

12. The image forming apparatus of claim 11, wherein the developer regulation member comprises a substrate, a titanium plated layer and a titanium oxide layer.

13. The image forming apparatus of claim 10, wherein the titanium compound comprises at least organic titanium compound or inorganic compound containing at least one of titanium oxide, TiC, TiAlN and TiAlCN.

14. An image forming method comprising:
forming a latent electrostatic image on a photoreceptor,
conveying developer with a developer carrying member,
forming a thin developer layer by coming in contact with the developer with a developer regulation member, and
developing the latent electrostatic image by using the thin developer layer,
wherein the developer regulation member comprises titanium or titanium compound excluding TiN and TiBN.

15. The image forming method of claim 14, wherein the developer comprises a colored particle including at least colorant and resin, and an inorganic particle, wherein the inorganic particle comprises a particle of metal oxide of Group IV (IUPAC 1989) element.

16. The image forming method of claim 14, wherein the developer regulation member comprises a layer formed by titanium plating.

17. The image forming method of claim 14, wherein the developer regulation member comprises a substrate, a titanium plated layer and a titanium oxide layer.

18. The image forming method of claim 14, wherein the titanium compound comprises at least organic titanium compound or inorganic compound containing at least one of titanium oxide, TiC, TiAlN and TiAlCN.
